(19) United States
(12) Patent Application Publication
(10) Pub. No.: US 2026/0050166 A1
(43) Pub. Date: Feb. 19, 2026

(54) WAVEGUIDES CO-OPTIMIZATIONS WITH LIGHT ENGINES IN AR GLASS MODULE

(71) Applicant: Applied Materials, Inc., Santa Clara, CA (US)

(72) Inventors: Yi XU, San Jose, CA (US); Deming Meng, San Jose, CA (US); Yangyang SUN, San Jose, CA (US); Jinxin FU, Fremont, CA (US)

(21) Appl. No.: 19/302,806

(22) Filed: Aug. 18, 2025

Related U.S. Application Data
(60) Provisional application No. 63/684,658, filed on Aug. 19, 2024.

(51) Int. Cl. G02B 27/01

(52) U.S. Cl. CPC G02B 27/0172; G02B 2027/0123

(57) ABSTRACT

Embodiments of the present disclosure generally relate to augmented reality systems. More specifically, embodiments described herein provide for augmented reality systems, methods of correcting an image projected into a waveguide, and related components. In one or more embodiments, an augmented reality system includes a light engine configured to emit an image and a waveguide including a substrate. The waveguide further includes an input coupler disposed over the substrate and configured to receive the image from the light engine. An output coupler is disposed over the substrate and configured to emit an outcoupled image. A controller is configured to generate corrective data based on one or more characteristics of the outcoupled image and adjust one or more components of the augmented reality system based on the corrective data.

### CROSS-REFERENCE TO RELATED APPLICATIONS

This application claims priority to U.S. Provisional Patent Application Ser. No. 63/684,658, filed Aug. 19, 2024, which is herein incorporated by reference.

### BACKGROUND

### Field

Embodiments of the present disclosure generally relate to augmented reality systems. More specifically, embodiments described herein provide for augmented reality systems, methods of correcting an image projected into a waveguide, and related components.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

Accordingly, what is needed in the art are augmented reality display systems.

### SUMMARY

Embodiments of the present disclosure generally relate to augmented reality systems. More specifically, embodiments described herein provide for augmented reality systems, methods of correcting an image projected into a waveguide, and related components.

In one or more embodiments, an augmented reality system includes a light engine configured to emit an image and a waveguide including a substrate. The waveguide further includes an input coupler disposed over the substrate and configured to receive the image from the light engine. An output coupler is disposed over the substrate and configured to emit an outcoupled image. A controller is configured to generate corrective data based on one or more characteristics of the outcoupled image and adjust one or more components of the augmented reality system based on the corrective data.

In one or more embodiments, a method of compensating an image projected through a waveguide includes projecting an image from a light engine into an input coupler of a waveguide and emitting an outcoupled image from an output coupler. The method further includes measuring one or more visual defects in the outcoupled image using a metrology system and generating corrective data based on the one or more visual defects. The method further includes adjusting one or more components of the light engine, the waveguide, or a combination thereof based on the corrective data.

In one or more embodiments, a controller for an augmented reality system, the controller includes a processor and a memory storing instructions that, when executed by the processor, cause the controller to project an image from a light engine into an input coupler of a waveguide and emit an outcoupled image from an output coupler. The instructions further cause the processor to cause the controller to measure one or more visual defects in the outcoupled image using a metrology system, generate corrective data based on the one or more visual defects, and adjust one or more components of the light engine, the waveguide, or a combination thereof.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A is a perspective frontal view of a waveguide, according to one or more embodiments.

FIG. 1B is a schematic top view of an augmented reality device in operation, according to one or more embodiments.

FIG. 2 is a flow diagram of a method for compensating an image projected from a light engine, according to one or more embodiments.

FIGS. 3A-3F are schematic representations of a projected image, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to augmented reality systems. More specifically, embodiments described herein provide for augmented reality systems, methods of correcting an image projected into a waveguide, and related components. In one or more embodiments, the present disclosure includes an augmented reality system having improved display performance. The disclosed augmented reality system reduces optical distortions, enhances consistency across viewing zones, and compensates for fabrication tolerances and user variability.

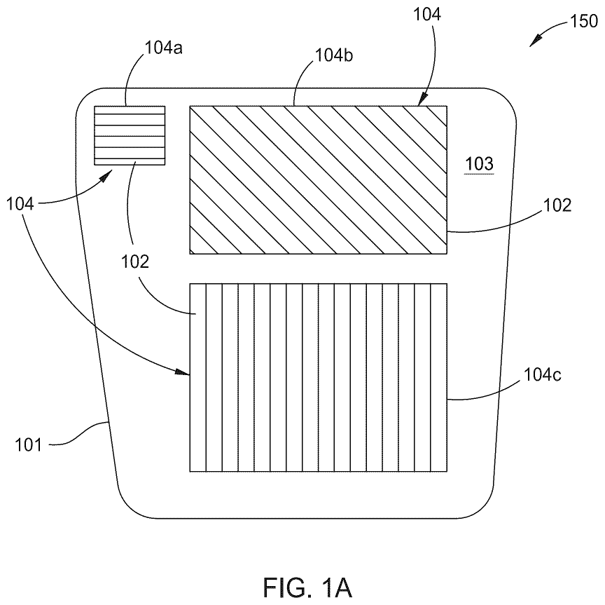

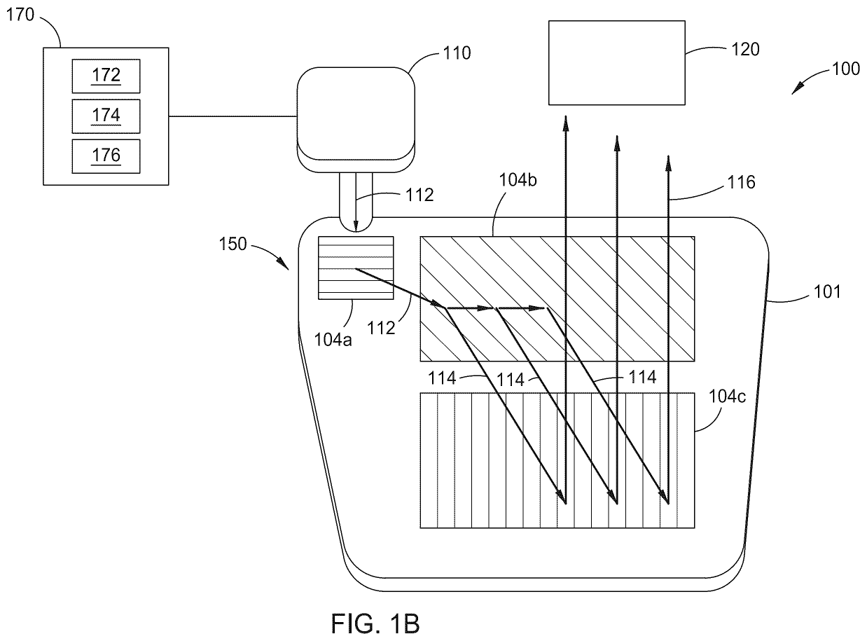

FIG. 1A is a perspective frontal view of a waveguide 150, according to one or more embodiments. It should be understood that the waveguide 150 described herein is exemplary and that other types of waveguides may be used or modified to accomplish aspects of the present disclosure. The waveguide 150 includes a plurality of structures 102, which may be disposed over, under, or on a first surface 103 of a substrate 101, or embedded within the substrate 101. The structures 102 are nanostructures having sub-micron critical dimensions, for example, a width less than 1 micrometer. Certain regions of the structures 102 form one or more gratings 104. These gratings 104 may be positioned over, under, or on the first surface 103 or on a second surface 105 that opposes the first surface 103. In one embodiment, the waveguide 150 includes at least an input coupler 104a and an output coupler 104c, corresponding respectively to an input coupling grating and an output coupling grating. In another embodiment, the waveguide 150 further includes a pupil expander 104b, which may be configured as a pupil expansion grating or a fold grating.

FIG. 1B is a schematic top view of an augmented reality system 100 in operation, according to one or more embodiments. The augmented reality system 100 includes the waveguide 150 and a light engine 110. The input coupler 104a, pupil expander 104b, and output coupler 104c are disposed in, on, or over the substrate 101. The light engine 110 is aligned with the input coupler 104a and is configured to project incident beams, such as a virtual image, toward the waveguide 150. The projected beams, referred to as input beam 112, are received by the input coupler 104a and guided into the waveguide 150. The input beam 112 propagates through the waveguide via total internal reflection until it interacts with the pupil expander 104b. The pupil expander redirects and distributes the light across a broader area while maintaining total internal reflection. The light then reaches the output coupler 104c, which directs the outcoupled beams 116 toward an eyebox 120. The eyebox is a location where the outcoupled beams are perceived as a displayed image. In one or more embodiments, a user's eye is located in the eye box. In one or more embodiments, a metrology device is located in the eyebox 120.

In one or more embodiments, the displayed image perceived in the eyebox 120 may include visual defects. These defects may include blurring, chromatic aberrations such as color fringing, image distortion, or other forms of non-uniformity that degrade image quality. Such issues may arise due to imperfections in the waveguide 150 which can occur during manufacturing of the waveguides 150. In one or more embodiments, the color non-uniformity is intrinsic to the waveguide design.

In one or more embodiments, the displayed image is monitored or measured to evaluate image quality. For example, a metrology system may be configured to measure positional misalignments, focus issues, or chromatic distortions as perceived in the eyebox 120. Measurement data is processed using a compensation algorithm, such as a demura algorithm, which identifies specific regions of the image that are impacted by imperfections in the waveguide 150 or deviations in the user's eye position. The algorithm generates corrective data based on this analysis.

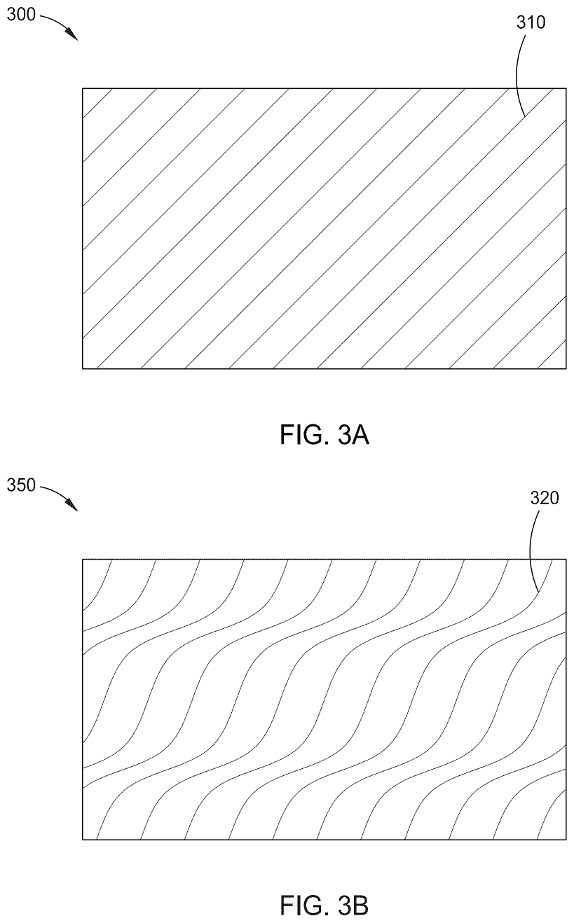

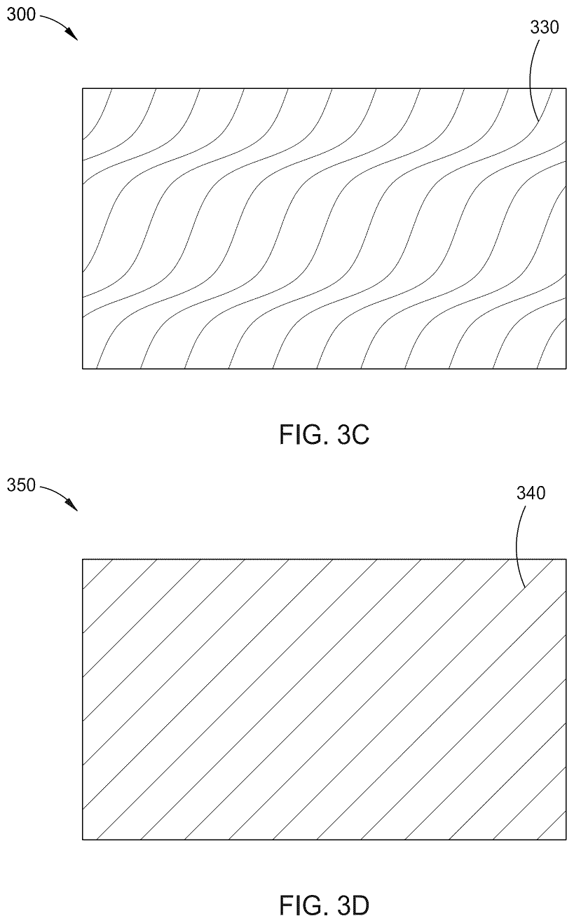

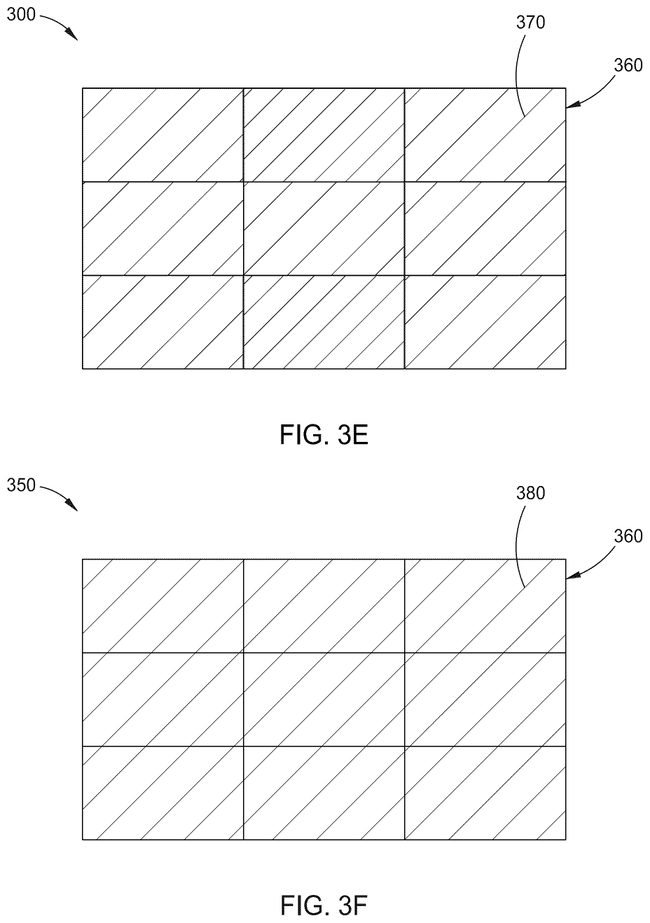

The corrective data may be used to modify one or more parameters of the light engine 110. For example, the intensity, color, or spatial position of light emitted from the light engine may be adjusted to account for the identified defects. In one or more embodiments, individual pixels of the light engine 110 are modified in a pixel-level compensation process. In another embodiment, groups of pixels are organized into segments 360 (See FIGS. 3E and 3F) and compensation is applied at a segment-level. For instance, the light engine 110 may include nine segments, each containing a plurality of pixels. Segment-level adjustments can independently modify emission characteristics across different regions of the light engine 110. Once adjusted, the light engine 110 emits a corrected image that accounts for the previously identified distortions. This corrected image propagates through the waveguide and is perceived in the eyebox 120 as a clearer and more accurate rendering of the intended visual content.

In some embodiments, the corrective data is used to adjust optical characteristics of the gratings 104a-104c. These adjustments may involve modifying the depth, pitch, shape, duty cycle, or orientation of the structures 102 forming the gratings 104a-104c. Such modifications can be introduced during the fabrication process or implemented post-fabrication using techniques such as etching, localized trimming, or application of tunable materials including liquid crystals or phase-change films. In one or more embodiments, the modifications are introduced during the design process. Adjusting the gratings can improve coupling efficiency and optimize the angular distribution of the outcoupled beams 116. This helps preserve image quality across varying eyebox 120 positions and user anatomical differences.

A controller 170 is configured to operate the light engine 110 and manage the compensation process. The controller 170 may receive image quality data from sensors, apply a demura algorithm, and generate corrective data. The controller may then update the light engine 110 and/or the gratings 104a-104c based on the corrective data.

The controller 170 includes a processor, such as a central processing unit (CPU) 172 and memory 174, which may include RAM, DRAM, ROM, or other non-transitory computer-readable media. The controller also includes support circuits 176 such as input/output interfaces, clock circuits, cache, and power supplies. The controller may execute software routines stored in memory 174 to implement the compensation methods described herein. The controller and the augmented reality system 100 may form part of a system for improving image quality in waveguide-based displays.

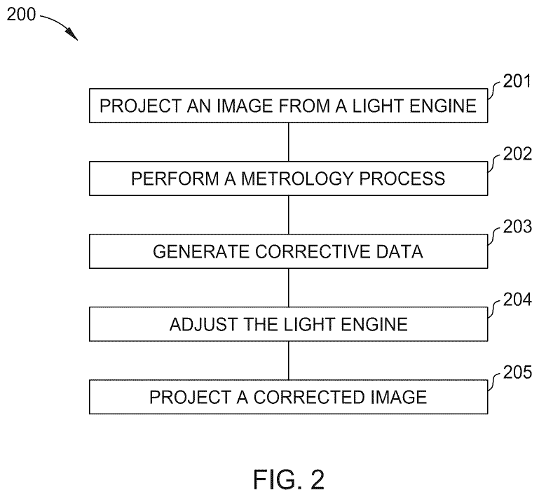

FIG. 2 is a flow diagram of a method 200 for compensating an image projected from a light engine 110, according to one or more embodiments. The method may be performed by the controller 170. At operation 201, an image is projected from the light engine 110 into the waveguide 150, enters through the input coupler 104a, propagates via total internal reflection, and exits through the output coupler 104c. Visual defects such as mura may occur due to grating non-uniformities or variations in the eyebox 120 location. In one or more embodiments, the non-uniformity is intrinsic to the waveguide design.

At operation 202, a metrology operation is performed to measure the quality of the projected image. This may include capturing the image directly from the light engine or as outcoupled through the waveguide 150 to the eyebox 120. Eye-tracking systems and image sensors may detect distortions, color shifts, or positional errors. Additionally, the gratings 104a-104c may be inspected to assess deviations from their intended design. These measurements are compiled into a dataset that characterizes the visual defects.

At operation 203, the dataset is processed using a compensation algorithm, such as a demura algorithm, to generate one or more corrective values. The algorithm may account for both system parameters and real-time user conditions. In one or more embodiments, the dataset includes the one or more visual defects in the outcoupled image measured by the metrology system. In one or more embodiments, the controller 170 generates the one or more corrective values by inputting the one or more visual defects in the outcoupled image measured by the metrology system into the demura algorithm stored within the memory 174 of the controller 170.

At operation 204, one or more components of the augmented reality system 100 are adjusted. In one or more embodiments, one or more components of the light engine 110 are adjusted. In one or more embodiments, individual pixels of the light engine are adjusted in order to apply fine-grained image correction. In one or more embodiments, one or more segments of the light engine 110 are adjusted, enabling efficient regional compensation. These changes may involve tuning brightness, color, timing, or phase at each pixel or segment.

In one or more embodiments, the one or more of the structures 102 of the gratings 104a-104c are adjusted. Adjustments may include changes to one or more structural features such as pitch, depth, shape, or angular orientation implemented during fabrication or by post-processing. In some embodiments, both the light engine 110 and gratings 104a-104c are modified in combination to optimize the final image.

At operation 205, the corrected image is projected through the waveguide. If compensation was applied to the light engine, the emitted image includes pre-distorted content designed to offset anticipated waveguide-induced artifacts. If grating compensation was performed, the waveguide may more uniformly propagate and emit light. In combination, these strategies improve the fidelity of the displayed image.

As a result, the image perceived in the eyebox 120 exhibits reduced mura, enhanced clarity, corrected color alignment, and greater consistency across eye positions. In some embodiments, the system dynamically repeats operations 201 through 205 in response to changes in eye position or environmental conditions. In other embodiments, precomputed correction data is stored for real-time retrieval.

FIGS. 3A-3F are schematic representations of a projected image, according to one or more embodiments. FIGS. 3A, 3C, and 3E are schematic representations of an in-coupled image 300, according to one or more embodiments. In one or more embodiments, the in-coupled image 300 is projected by the light engine 110 into the input coupler 104a of the waveguide 150. FIGS. 3B, 3D, and 3F are schematic representations of an out-coupled image 350, according to one or more embodiments. In one or more embodiments, the out-coupled image 350 is projected from the output coupler 104c of the waveguide 150 to the eyebox 120.

FIG. 3A shows the in-coupled image 300 prior to applying any compensation, according to one or more embodiments. In one or more embodiments, the in-coupled image 350 is a uniform image, such as a white image. The uniform image is represented by the straight lines 310. In one or more embodiments, during a projection operation, such as operation 201 of the method 200 described herein, the light engine 110 projects the uniform in-coupled image 300, into the input coupler 104a of the waveguide 150. The in-coupled image 300 is guided through the waveguide 150 by total internal reflection, and emitted by the output coupler 104c to form the outcoupled image 350 shown in FIG. 3B.

FIG. 3B shows the out-coupled image 350 prior to applying any compensation, according to one or more embodiments. In one or more embodiments, visual defects, represented by the wavy lines 320, may appear in the outcoupled image 350 due to one or more factors such as the eyebox 120 being offset from the output coupler 104c and/or structural imperfections in the structures 102 of one or more of the gratings 104a-104c. These defects may include discoloration, brightness non-uniformity, or chromatic distortion.

FIG. 3C illustrates the in-coupled image 300 after applying pixel-level image compensation in accordance with method 200. In one or more embodiments, individual pixels of the light engine 110 are adjusted based on corrective data generated by a metrology system. Pixel-level corrections may include modifications to brightness, timing, color intensity, emission angle, or a combination thereof. In one or more embodiments, the in-coupled image 300 is a compensated image, such as a pre-blurred. In one or more embodiments, the compensated image is a pre-compensated image. The compensated pixels of the compensated image are represented by the wavy lines 330. In one or more embodiments, during a corrected image projection operation, such as operation 205 of the method 200 described herein, the light engine 110 projects the compensated in-coupled image 300, into the input coupler 104a of the waveguide 150. The in-coupled image 300 is guided through the waveguide 150 by total internal reflection, and emitted by the output coupler 104c to form the outcoupled image 350 shown in FIG. 3D.

FIG. 3D shows the out-coupled image 350 after applying pixel-level image compensation in accordance with method 200. In one or more embodiments, the out-coupled image 350 exhibits reduced visual defects compared to the uncompensated out-coupled image shown in FIG. 3B. In one or more embodiments, the compensated pixels are calibrated so that after the in-coupled image 300 is projected through the waveguide 150 and out-coupled as the out-coupled image 350 to the eyebox 120, the image is perceived in the eyebox 120 as a uniform image, represented by the straight lines 340.

FIG. 3E illustrates the in-coupled image 300 after applying segment-level image compensation in accordance with method 200. In one or more embodiments, one or more segments 360 of the light engine 110 are adjusted based on corrective data generated by a metrology system. Each segment 360 includes a plurality of pixels. Segment-level corrections may include modifications to brightness, timing, color intensity, emission angle, or a combination thereof. In one or more embodiments, the in-coupled image 300 is a compensated image, such as a pre-blurred. The compensated pixels of the compensated image are represented by the offset lines 370 within each segment 360. In one or more embodiments, during a corrected image projection operation, such as operation 205 of the method 200 described herein, the light engine 110 projects the compensated in-coupled image 300, into the input coupler 104a of the waveguide 150. The in-coupled image 300 is guided through the waveguide 150 by total internal reflection, and emitted by the output coupler 104c to form the outcoupled image 350 shown in FIG. 3F.

FIG. 3F shows the out-coupled image 350 after applying segment-level image compensation in accordance with method 200. In one or more embodiments, the out-coupled image 350 exhibits reduced visual defects compared to the uncompensated out-coupled image shown in FIG. 3B. In one or more embodiments, the compensated segments 360 are calibrated so that after the in-coupled image 300 is projected through the waveguide 150 and out-coupled as the out-coupled image 350 to the eyebox 120, the image is perceived in the eyebox 120 as a uniform image, represented by the straight lines 380.

The compensation techniques disclosed herein, including pixel-level and segment-level adjustments as well as adjusting one or more structural features of the gratings 104a-104c offer benefits for waveguide-based display systems. These techniques enable improved image uniformity, reduced mura, corrected color alignment, and enhanced visual clarity across a range of user eye positions. By addressing both static optical imperfections and dynamic user-specific variations, these methods improve system robustness and overall user experience. Furthermore, the corrections can be applied in real time, enabling adaptive compensation in response to changing viewing conditions such as head movement, eye tracking, or lighting changes.

In some embodiments, the corrective process is iterative or adaptive. The system may continuously or periodically repeat the compensation method (e.g., operations 201 through 205) to refine image quality over time. This allows the system to respond to factors such as thermal drift, component aging, or shifting user gaze. In other embodiments, correction data for various eye positions and system states is precomputed and stored in a lookup table or predictive model. During operation, the system retrieves the appropriate correction data in real time, enabling fast and accurate image compensation without interrupting the display.

Benefits of the present disclosure include improved display performance in augmented reality systems using waveguide optics. The disclosed system reduces optical distortions, enhances consistency across viewing zones, and compensates for fabrication tolerances and user variability.

It is contemplated that one or more features disclosed herein may be combined in a variety of ways. For example, any combination of the waveguide 150, substrate 101, structures 102, first surface 103, gratings 104a-104c, second surface 105, augmented reality system 100, light engine 110, input beam 112, reflected beams 114, outcoupled beams 116, eyebox 120, controller 170, method 200, in-coupled image 300, the out-coupled image 350, and/or the segments 360 may be used together. These combinations may yield systems and methods that provide some or all of the advantages described herein.

While the foregoing is directed to examples of the present disclosure, other and further examples of the disclosure may be devised without departing from the basic scope thereof, and the scope thereof is determined by the claims that follow.

What is claimed is:

1. An augmented reality system comprising:
a light engine configured to emit an image;
a waveguide comprising:
a substrate;
an input coupler disposed over the substrate and configured to receive the image from the light engine; and
an output coupler disposed over the substrate and configured to emit an outcoupled image; and
a controller configured to generate corrective data based on one or more characteristics of the outcoupled image and adjust one or more components of the augmented reality system based on the corrective data.

2. The augmented reality system of claim 1, wherein the components one or more pixels of the light engine and the corrective data comprises adjustments to the one or more pixels of the light engine.

3. The augmented reality system of claim 1, wherein the corrective data comprises adjustments to one or more segments of the light engine, each segment comprising a plurality of pixels.

4. The augmented reality system of claim 1, wherein the light engine is configured to emit a compensated image.

5. The augmented reality system of claim 1, wherein the controller is further configured to adjust structural features of the input coupler, the output coupler, or a combination thereof.

6. The augmented reality system of claim 5, wherein the one or more structural features include at least one of pitch, depth, shape, duty cycle, or orientation.

7. The augmented reality system of claim 1, further including a metrology system configured to measure one or more parameters of the outcoupled image.

8. The augmented reality system of claim 7, wherein the controller is further configured to receive a dataset including one or more visual defects in the outcoupled image measured by the metrology system.

9. The augmented reality system of claim 8, wherein generating corrective data based on one or more characteristics of the outcoupled image comprises inputting the dataset into a demura algorithm stored within a memory of the controller.

10. A method of compensating an image projected through a waveguide, the method comprising:
projecting the image from a light engine into an input coupler of a waveguide;
emitting an outcoupled image from an output coupler of the waveguide;
measuring one or more visual defects in the outcoupled image using a metrology system;
generating corrective data based on the one or more visual defects; and
adjusting one or more components of the light engine, the waveguide, or a combination thereof based on the corrective data.

11. The method of claim 10, adjusting the light engine comprises adjusting individual pixels of the light engine in a pixel-level compensation operation.

12. The method of claim 10, wherein adjusting the light engine comprises adjusting segments of the light engine, each segment including a plurality of pixels.

13. The method of claim 10, wherein generating the corrective data comprises executing a demura algorithm.

14. The method of claim 10, wherein adjusting the waveguide comprises adjusting one or more structural features of at least one of the input coupler, a pupil expander, the output coupler, or a combination thereof based on the corrective data.

15. The method of claim 14, wherein the one or more structural features comprise at least one of pitch, depth, shape, or angular orientation.

16. The method of claim 10, further comprising projecting a corrected image through the waveguide.

17. A controller for an augmented reality system, the controller comprising:
a processor and a memory storing instructions that, when executed by the processor, cause the controller to:
project an image from a light engine into an input coupler of a waveguide;
emit an outcoupled image from an output coupler;
measure one or more visual defects in the outcoupled image using a metrology system;
generate corrective data based on the one or more visual defects; and
adjust one or more components of the light engine, the waveguide, or a combination thereof.

18. The controller of claim 17, wherein adjusting the light engine comprises adjusting individual pixels of the light engine in a pixel-level compensation operation.

19. The controller of claim 17, wherein adjusting the light engine comprises adjusting segments of the light engine, each segment including a plurality of pixels.

20. The controller of claim 17, adjusting the waveguide comprises adjusting one or more structural features of at least one of the input coupler, a pupil expander, the output coupler, or a combination thereof based on the corrective data.
